(19) United States
(12) Patent Application Publication
(10) Pub. No.: US 2010/0260099 A1
(43) Pub. Date: Oct. 14, 2010

(54) HSPA Evolution Architecture

(76) Inventors: Timothy Frost, Bristol (GB); David Fox, Reading (GB); Gavin Wong, Surrey (GB); Christopher David Pudney, Newbury (GB)

Correspondence Address: MUIRHEAD AND SATURNELLI, LLC, 200 FRIBERG PARKWAY, SUITE 1001, WESTBOROUGH, MA, 01581, US

(21) Appl. No.: 12/308,310

(22) PCT Filed: Jun. 12, 2007
(86) PCT No.: PCT/GB2007/002162

§ 371 Date: Jun. 18, 2010

(30) Foreign Application Priority Data
Jun. 12, 2006 (GB) 0611538.0
Nov. 3, 2006 (GB) 0621971.1
Jan. 5, 2007 (GB) 0700221.5

(51) Int. Cl. H04W 72/00

(52) U.S. Cl. 370/328

(57) ABSTRACT

A telecommunications network, including an evolved base station node having a node controller and a first radio network controller (RNC), the node controller configured to communicate with user terminals, and the first radio network controller configured to communicate with a packet switched component of a core network, but not with a circuit switched component, may further include a second RNC that communicates with the node controller and also communicates with the packet switched component of the core network and a circuit switched component. A method of establishing communication between a user terminal and the core network via the second RNC, when the user terminal has a control plane connection with the evolved base station node, such that the first RNC is the serving RNC (SRNC), may include tunnelling communication set up messages over the control plane between the node controller and the core network via the second RNC.

This invention relates to a system and method for use in a telecommunications network employing High Speed Packet Access (HSPA) technology. More particularly, the invention relates to an evolved HSPA (eHSPA) collapsed architecture for utilising HSPA technology and utilising it with the existing UMTS radio access network architecture.

### BACKGROUND

Since its introduction, third-generation (3G) UMTS cellular technology has provided the ability to deliver more voice channels and higher-bandwidths to user equipment/terminals (UEs) such as mobile handsets. However, there is a desire for higher speed data.

In this regard High-Speed Packet Access (HSPA) was developed. HSPA is a protocol that provides a transitional platform for UMTS-based 3G networks to offer higher data transfer speeds, and so bridges the gap between 3G networks and the Internet. In other words, HSPA is able to dramatically improve the performance of a radio network, whilst maintaining the underlying architecture. HSPA is made up of High Speed Downlink Packet Access (HSDPA) and High Speed Uplink Packet Access (HSUPA).

HSPA provides impressive enhancements over WCDMA, including higher throughputs, and faster response times, particularly for web-browsing. More importantly, HSPA offers a large spectrum efficiency increase, which translates into either much higher throughputs or significantly more data users on a single frequency or carrier. The substantial increase in data rate and throughput is achieved by implementing a fast and complex channel control mechanism based upon short physical layer frames, Adaptive Modulation and Coding (AMC), fast Hybrid-ARQ (Automatic Repeat-reQuest) and fast scheduling. The exact implementation of HSPA is known, and so will not be described further here.

HSPA can be implemented as an upgrade to and in co-existence with deployed UMTS/WCDMA networks. The cost of deploying HSPA chiefly lies in base station and Radio Network Controller (RNC) software/hardware upgrades. Most base stations (also known as Node Bs) will need upgrades to cope with the increased data throughput and the consequences of moving to a more complex protocol.

Advancements have also been made to HSPA, and the improved version has been termed evolved HSPA (eHSPA). In this regard, an evolved HSPA Node B architecture 10 has been proposed, which is shown in FIG. 1. In addition to the standard Node B functionality 13, these nodes have RNC functionality, which, when in use, will provide the roles of serving RNC (SRNC) 11 and controlling RNC (CRNC) 12. The RNC functionality is provided alongside the Node B functionality within the base station/evolved Node B 10. Thus this eHSPA architecture can be described as “a collapsed RNC/Node B” architecture. With this architecture the call set up delay can be reduced, as there is minimal latency associated with the communications between the RNC functionality 11, 12 and the Node B functionality 13. This eHSPA “collapsed RNC/Node B” architecture enables user terminals to connect to the eHSPA Node B without requiring any modifications.

It is to be appreciated that the evolved HSPA Node B architecture of FIG. 1 has been designed so as to handle packet switched data communications more efficiently. In this regard, the SRNC 11 within the evolved HSPA Node B 10 is able to communicate directly with the Packet Switched (PS) Component of the Core Network. More specifically, the evolved HSPA Node B communicates directly with the GPRS Service Node (GSN) 14 via the Iu-PS interface. The GSN 14 is made up of the Serving GPRS Support Node (SGSN) and the Gateway GPRS Support Node (GGSN), which connects to packet data networks such as the Internet.

While this evolved HSPA Node B is able to provide improved data rates through its architecture and use of HSPA, it is also imperative that the architecture is compatible with systems handling circuit switched (CS) voice communications. From an operator point of view, in order to maximise radio spectrum efficiency, it is also important that CS calls can be handled on the same cells as HSPA traffic. The same issue applies to PS calls using 3GPP Release 99 channels.

3GPP is a cooperation of international standards bodies for the promotion of cellular systems that support high-speed data. 3GPP standards are called “Releases” and “Release 99” defines the first UMTS 3G networks incorporating a CDMA air interface.

For UEs that are not using HSPA channels, which includes UEs that are not HSPA compatible, it may not be ideal to handle these calls using the collapsed RNC-Node B architecture, because this architecture does not support soft handover, and CS calls need to be handled with an architecture that supports efficient soft handover. These UEs therefore may not connect to the GSN directly from the eHSPA Node B, and therefore need an alternative route to the core network from the Node B part of the eHSPA Node B.

In this regard, the evolved HSPA Node B can be connected to the Core Network via legacy UTRAN, which does support efficient soft handover. With reference to FIG. 1 the Node B functionality 13 within the evolved HSPA Node B would communicate with the RNC 15 of the UTRAN network via interface Iub. The RNC 15 in turn communicates with the Mobile Switching Centre (MSC) 17 of the CS/PS component of the core network, as applicable.

One difficulty with this approach, however, arises with the multi-RAB (Radio Access Bearer) scenario. More specifically, if a user terminal already has a PS connection with the GSN via the eHSPA Node B, and a CS connection is additionally required, then, since the SRNC of the evolved HSPA Node B cannot provide a CS connection, SRNS relocation is required, at least in the control plane, to a legacy RNC before a circuit switched connection can be fully established.

This is not a straightforward matter, however, in view of the architectural difference of the evolved HSPA Node B to standard Node Bs.

A further requirement of the FIG. 1 architecture is that legacy terminals are able to obtain a full service from the evolved HSPA Node B, such that they can gain access to packet switched data networks as well as circuit switched data networks. The difficulty here is that at least for terminals wanting to make CS calls, which are not compatible with HSPA, to access the CS core network via the evolved HSPA Node B, the RNC 11 within the evolved HSPA Node B would need to support the legacy CS domain connectivity, in addition to connectivity to the PS domain.

In addition, as stated earlier, it may be preferable to connect Release 99 PS calls to the legacy RNC because this architecture is more suited for handling soft handover, which may be needed for Release 99 channels where HARQ (Hybrid Automatic-Repeat Request) retransmissions are not possible.

Therefore the UTRAN architecture allows for CS and data communications for such legacy call types and those terminals not supporting HSPA to be routed to the PS/CS component of the Core Network 14 via the UTRAN RNC 15. A difficulty with this is that the evolved Node B may not be able to determine that the terminal with which it is communicating is a legacy terminal nor is it able to determine the service required by the terminal until after a Radio Resource Control (RRC) connection has been set up with the terminal. Therefore, upon receiving an RRC Connection Request from such a terminal, the evolved Node B commences setting up the connection, and establishing its internal RNC as the SRNC. Accordingly, once the shortcomings of the user terminal are determined, it becomes necessary to transfer the requested communication to the legacy UTRAN. Again, this is not a straightforward matter in view of the architectural differences between the evolved Node B and standard Node Bs.

As it has also been proposed to use evolved Node Bs in the System Architecture Evolution/Long Term Evolution (SAE/LTE) network, which is a 4G technology, currently in development, similar problems apply in this new network. An example LTE architecture is shown in FIG. 6.

FIG. 6 shows two evolved Node Bs in communication with the MME/UPE via the S1 interface plane. The two evolved Node Bs are also able to communicate with UEs via the Ux air interface.

The Mobility Management Entity (MME) is typically allocated the functionality of managing and storing the UE control plane context, generating temporary IDs, UE authentication, authorisation of Tracking Areas (TA) and PLMNs and mobility management. The User Plane Entity (UPE) is typically allocated the functionalities of managing and storing UE user plane context, DL User Plane termination in LTE_IDLE, ciphering, mobility anchor, packet routing and forwarding and initiation of paging. The control plane between the eNode B and the MME is typically described as S1-C, while the user plane between the eNode B and the UPE is typically described as S1-U. The MME/UPE can be considered as an evolved version of the Re-6 SGSN/GGSN nodes. The MME/UPE can be considered as two separate nodes, or as one node. Also, as the exact functionality of the MME/UPE is still being finalised by 3GPP, all the functionalities above are only to be taken as guides to operation of LTE/SAE networks.

The LTE/SAE network will be exclusively packet-switched (PS) and IP based, and the circuit-switched (CS) core network will not exist in LTE. Hence voice and other services previously delivered over the CS core network in UMTS will be provided via a PS IP core and IP Multimedia Subsystem (IBS), an architecture for delivering IP multimedia services to end users.

Therefore, if we wish to allow a migration path from “eHSPA architecture connected to UMTS core network” to “eHSPA architecture connected to SAE core network” in order to continue to handle legacy “UEs NOT supporting SAE connectivity” on the same cell as “UEs that DO support SAE connectivity”, then it may again be beneficial to re-use the concept of connectivity from eHSPA Node B to the legacy RNC for connecting such “non-SAE supporting UEs” to the UMTS core network, with the new architecture. In other words, where the evolved Node B in the LTE network receives an RRC Connection Request from a non-compatible terminal, it will be necessary to transfer the requested communication to the legacy UTRAN. Again, this is not a straightforward matter in view of the architectural differences between the evolved Node B and standard Node Bs, as well as between the LTE/SAE network and UTRAN. This will apply to both CS and PS connection requests from non-compatible terminals.

A further problem has arisen in the proposed LTE/SAE network, this time in view of the RNC functionalities being moved into the Node B. With the RRC function being moved to the Node B, this causes all functionality below RRC to also be moved to the Node B, and thus ciphering would be in the HSPA Node B. While this is a feasible approach, it would be advantageous for other options to be available.

### SUMMARY OF THE INVENTION

According to a first aspect the present invention provides, in a telecommunications network, including a base station node having a node controller component and a first radio network controller (RNC) component, the first radio network controller component configured to communicate with a packet switched component of a core network, but not with a circuit switched (CS) component, the telecommunications network further including a second RNC configured to communicate with the node controller and also to communicate with the packet switched component of the core network and the circuit switched component; a method of establishing a communication between a given user terminal and the core network via the second RNC, when a given user terminal has at least a control plane connection with the base station node, such that the first RNC is the serving RNC (SRNC), the method comprising: transmitting at least one message over the control plane between the node controller and the core network via the second RNC, such that the message is tunnelled between the node controller and the second RNC.

According to a second aspect, the present invention provides a base station node having a node controller component and a first radio network controller (RNC) component, the first radio network controller configured to communicate with a packet switched component of a core network using HSPA, but not with a circuit switched component, the node controller further configured to transmit at least one communication set up message over the control plane between the node controller and the core network via a second RNC, such that the at least one message relates to a first protocol and the base station node is configured to encapsulate the message in a control plane container according to a second protocol.

According to a third aspect, the present invention provides in a telecommunications network, including a base station node having a node controller component and a first radio network controller (RNC) component, the first radio network controller configured to communicate with a packet switched component of a core network, but not with a circuit switched component, the telecommunications network further including a second RNC configured to communicate with the node controller and also to communicate with the packet switched component of the core network and the circuit switched component; a method of initiating SRNS relocation from the first RNC to the second RNC, when a given user terminal has at least a control plane connection with the base station node, such that the first RNC is the serving RNC (SRNC), the method comprising: transmitting an SRNS relocation message as well as the SRNS context, in the case where the terminal does not already have an existing Packet switched connection, from the node controller to the second RNC across the Iub interface.

Preferably, an SRNS context is transmitted with the SRNS relocation message. This is necessary where the user terminal does not already have an existing packet switched connection.

These aspects of the invention therefore enable the integration of evolved HSPA Node Bs into legacy UTRAN networks. They also provide improved and more efficient arrangements for user terminals to make use of the benefits of eHSPA Node Bs whilst still being able to access network services that are not compatible with such Node Bs.

According to a fourth aspect, the present invention provides, in a telecommunications network, including a base station node having a node controller component and a first radio network controller (RNC) component, the first radio network controller component configured to communicate with a packet switched or IP component of a core network, but not with a circuit switched (CS) component, the telecommunications network further including a second RNC configured to communicate with the node controller and also to communicate with the packet switched component of the core network and the circuit switched component; a method of establishing a communication between a given user terminal and the core network via the second RNC, when a given user terminal has at least a Control plane connection with the base station node, such that the first RNC is the serving RNC (SRNC), the method comprising: transmitting at least one message over the control plane between the first RNC component of the base station node and the second RNC, such that the message is transmitted over an Iur interface.

According to a fifth aspect the present invention provides, in a telecommunications network, including a base station node having a node controller component and a first radio network controller (RNC) component, the first radio network controller component configured to communicate with a packet switched or IP component of a core network, but not with a circuit switched (CS) component, the telecommunications network further including a network controller configured to communicate with the node controller and also to communicate with the packet switched component of the core network; a method of communicating with a given user terminal, the method comprising: the base station node communicating with the given user terminal in regard to one or more SRNC control plane functionalities; and the network controller communicating with the user terminal in relation to one or more SRNC user plane functionalities.

### BRIEF DESCRIPTION OF THE FIGURES

FIG. 1 illustrates an evolved Node B connected to a legacy UTRAN, an architecture in which the present invention can be implemented.

FIG. 2 illustrates a signalling diagram of a user terminal establishing a CS connection via the eHSPA Node B, from idle, or when a PS connection already exists, according to a first embodiment of the invention;

FIG. 3 illustrates an example of a signalling diagram for an SRNS Relocation;

FIG. 4 illustrates a signalling diagram of a user terminal establishing a CS connection via the eHSPA Node B, from idle, or when a PS connection already exists, according to a further embodiment of the invention; and

FIG. 5 illustrates a signalling diagram of a user terminal establishing a CS connection via the eHSPA Node B, from idle, or optionally when a PS connection already exists, according to a still further embodiment of the invention;

FIG. 6 illustrates an example architecture for the proposed SAE/LTE network;

FIG. 7 illustrates an example control plane architecture in an LTE/SAE network according to an embodiment of the invention;

FIG. 8 illustrates an example user plane architecture in an LTE/SAE network according to an embodiment of the invention;

FIG. 9 illustrates an LTE/SAE architecture with evolved eHSPA Node Bs illustrating SRNC handover, without soft handover, for an LTE/SAE compatible terminal and a legacy terminal according to embodiments of the invention; and

FIG. 10 illustrates an LTE/SAE architecture with evolved eHSPA Node Bs illustrating SRNC handover, with soft handover, for an LTE/SAE compatible terminal and a legacy terminal according to embodiments of the invention.

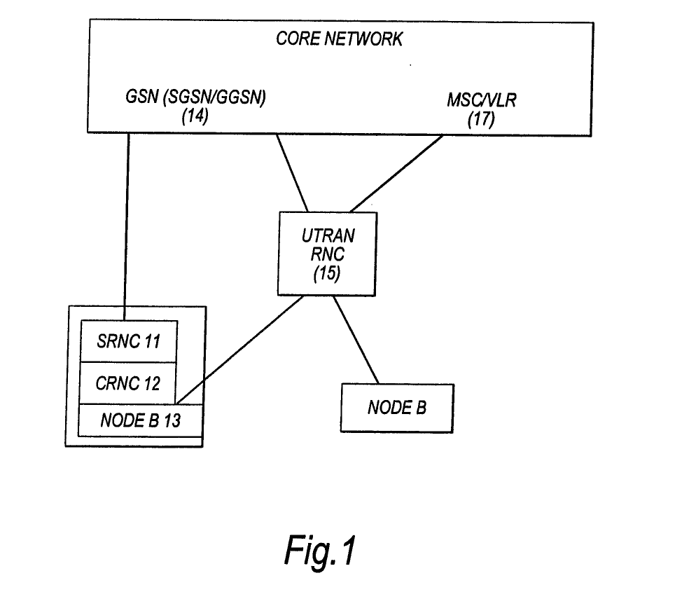

### DETAILED DESCRIPTION OF EMBODIMENTS OF THE INVENTION

A first embodiment of the invention will now be described in relation to a user terminal, seeking a connection to a circuit switched component of a core network via the evolved node B 10 in a UMTS radio access network. This embodiment will be described in relation to the user terminal seeking a connection from idle, although it is also applicable to the situation of the user terminal already having a PS connection.

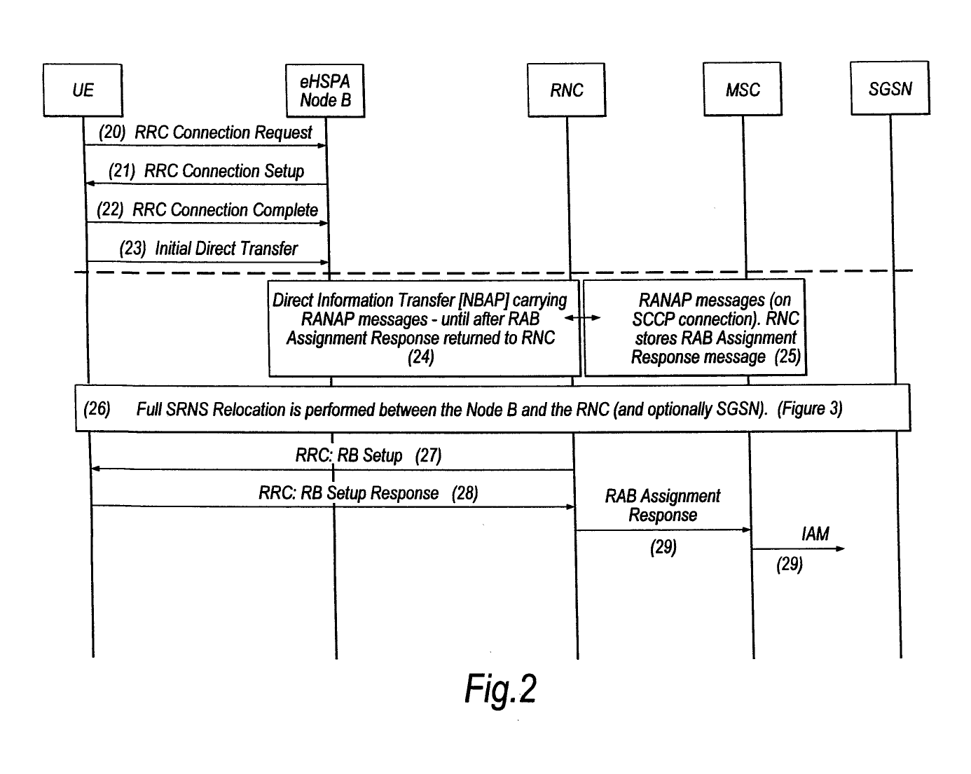

With reference to FIG. 2, showing an example of an appropriate signalling diagram, the user terminal (UE) initiates communication by sending a “Radio Resource Control (RRC) Connection Request” 20 to the nearest Node B, which in this instance is the eHSPA Node B 10. Upon receiving this request, the Node B, at this point in the communication being generally unable to determine whether the user terminal requires access to the circuit switched component or the packet switched component of the core network, particularly where the terminal is a legacy terminal, proceeds with registering its internal RNC 11 as the serving RNC (SRNC).

Once the RRC connection has been set up, the Node B notifies the user terminal via an “RRC Connection Setup” message 21. The user terminal acknowledges this with an “RRC connection complete” message 22. Next the user terminal sends an “Initial Direct Transfer” message 23 to the evolved HSPA Node B 10. This message includes a service request, and so it is from this message that the evolved HSPA Node B can now determine whether the legacy terminal requires a circuit switched connection to the core network or a packet switched connection. In this instance, the terminal requires a circuit switched connection, with which the Node B's internal RNC is not compatible.

From here, once the eHSPA Node B has received the “Initial Direct Transfer” message 23, it is clear that the eHSPA Node B's internal SRNC 11 cannot be used to communicate directly with the CS Core Network. This is a consequence of the architecture of the evolved HSPA Node B, which has the internal SRNC 11 only in direct communication with the PS component 14 of the Core Network.

Therefore, according to this embodiment of the invention, the SRNC functionality 11 of eHSPA Node B 10 must communicate with the CS core network via the legacy UTRAN RNC 15 in order to establish the CS call. The eHSPA node achieves this by communicating RANAP messages 24, 25 to the MSC of the CS Core Network 12, which are tunnelled via the Iub interface using a container (from here on called “direct information transfer” container), between eHSPA Node B 10 and UTRAN RNC 15.

In FIG. 2, no specific detail of the actual RANAP messages sent in the “Direct Information Transfer” container messages has been given, as their actual content and order is not important to this embodiment of the invention. It is enough merely to appreciate that the messages communicated between the evolved HSPA Node B and the MSC of the CS Core network are for the purpose of call set up and would typically include the initial UE message, as well as security mode commands.

As the initial message 24 from the evolved HSPA Node B is intended for communication to the CS component 17 of the Core Network, the message needs to be a RANAP message, since this is the protocol that the Core Network is expecting to receive. RANAP is the signalling protocol carried over the Iu interface between the Core Network and the UTRAN.

Therefore, according to the present embodiment of the invention, the Node B encapsulates this RANAP message into a “Direct Information Transfer” container, which is an NBAP container, for transmission over the Iub interface towards the UTRAN RNC 15. NBAP is a standard protocol for the Iub interface for control communications between an RNC and a Node B. The UTRAN RNC 15 is the RNC to which the SRNC functionality is to be reallocated.

At this stage in the procedure the UTRAN RNC is not directly involved in the communications between the CS component of the Core Network (i.e. the MSC), and the Node B, and so, upon receiving the NBAP “Direct Information Transfer” container, the RNC merely unpacks the RANAP message 25 and transmits it to the MSC 17 of the CS core network using an SCCP connection. SCCP is the routing protocol of the Transport layer of the Iu interface control to plane, and serves to route messages to a specified destination address.

From this it is apparent that the RNC has no involvement in acting on the details of the RANAP message at this stage—it merely acts as a conduit for the message towards the Core Network. It is also to be appreciated that the core network need not be aware that it is communicating with the evolved Node B, rather than an SRNC.

Upon receiving the “Direct Information Transfer” message from the evolved Node B, the Core Network responds, such as with a “Common ID” RANAP message (not shown). In the downlink direction, the opposite of what has just been described occurs. That is, the Core Network transmits the RANAP message towards the UTRAN RNC. The RNC packs the RANAP message into an NBAP “Direct Information Transfer” container and relays the message to the evolved Node B, which reads the message and acts accordingly. In this instance, the message is intended for the user terminal, and so the Node B would forward the message to the user terminal for it to provide the requested authentication.

A further RANAP message that would subsequently be transmitted by the Core Network, once the initial RANAP message has been received, is the “RAB Assignment Request” message, to establish the Radio Access Bearer (RAB) for the communication. This RANAP message would again be transmitted to the UTRAN RNC.

In this embodiment of the invention, upon receiving the “RAB Assignment Request” message, the UTRAN RNC stores a copy of the request, encapsulates the message in a NBAP “Direct Information Transfer” container and forwards it on to the Node B over the Iub interface. Upon receiving the “RAB Assignment Request”, the Node B sets up the Radio Link configuration, and then responds with a “RAB Assignment Response” RANAP message, which is again encapsulated in a “Direct Information Transfer” container and transmitted towards the UTRAN RNC over the Iub interface. The Node B then commences performing the SRNS Relocation 26 towards the UTRAN RNC. In this embodiment of the invention, when the UTRAN RNC receives the “RAB Assignment Response” message, it buffers the message and waits for the SRNS Relocation to be triggered by the Node B and for the SRNS context to be subsequently received.

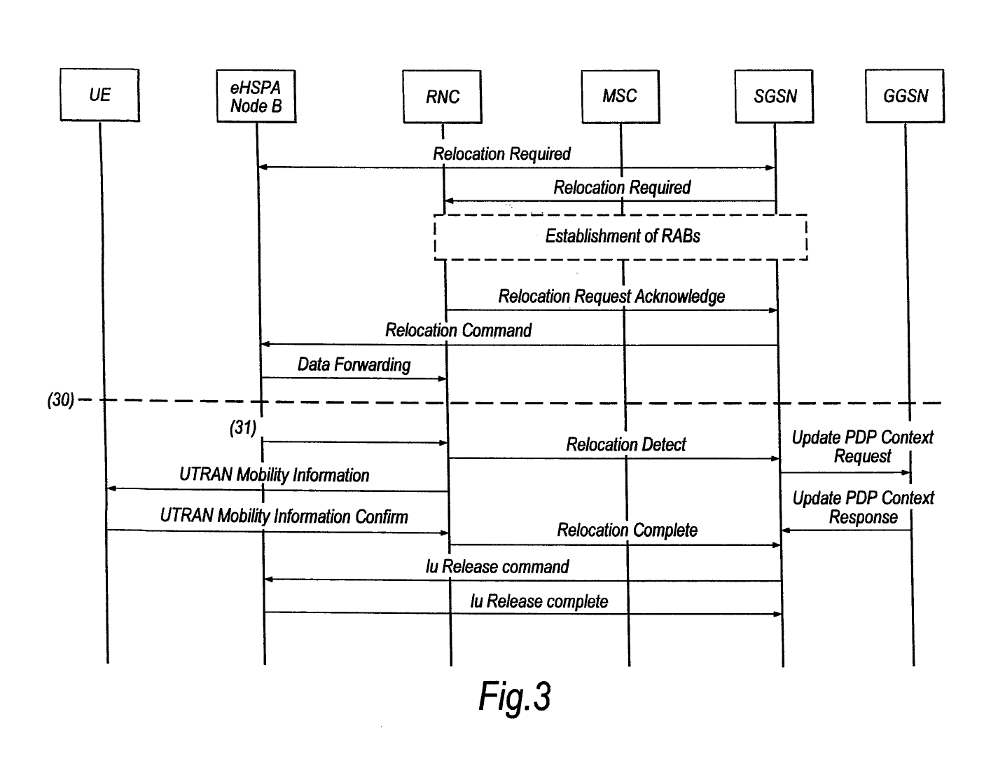

An example of an applicable SRNS Relocation procedure, where no connection to the core network current exists, is shown in FIG. 3, commencing below the dotted line 30. (The procedure above the dotted line 30 relates to the procedure for moving an Iu-PS connection from an enhanced Node B's SRNC to a legacy RNC, where an Iu-PS connection already exists.)

The procedure below the dotted line in FIG. 3 is mainly performed by the UTRAN RNC, and its functionality is as detailed in UTRAN 3GPP Release 7 specifications, from the stage when the UTRAN RNC receives the message “Relocation Commit” triggering SRNS Relocation if there is no existing core network connection. According to the present embodiment of the invention, instead of this message being forwarded between legacy RNCs over the Iur interface using the RNSAP protocol, an equivalent message 31 is forwarded by the evolved Node B to the UTRAN RNC over the Iub interface using the NBAP protocol. In addition, the full SRNS context may be transmitted across the Iub interface within this message. Particularly this is needed if there is no existing core network connection. If there is an existing PS core network connection, then the message may be used to inform the UTRAN RNC that it may consider itself the new Serving RNC once the SRNS context has been transferred over the Iu-PS interfaces.

Once SRNS Relocation has been triggered by the eHSPA node, subsequent steps below the dotted line 30 in FIG. 3 are standard steps currently used in to the UTRAN SRNS Relocation procedure and will not be described further here.

After the SRNS Relocation is successfully completed, the UTRAN RNC becomes the SRNC and from that point stops relaying RANAP messages to the is eHSPA node B, and starts to function as the SRNC for the user. The eHSPA Node B also again starts to function as a normal Node B.

It is to be appreciated, however, that in this embodiment, the user plane resources have not yet been fully allocated to the new SRNC, since the eHSPA Node B did not have the Iub user plane resources established towards it before performing the SRNC Relocation.

Therefore, again referring to FIG. 2, once SRNS Relocation 26 has been effected, and the UTRAN RNC has become the SRNC, it establishes the Iub user plane towards the Node B, then sends the user terminal the “RRC: RB setup” message. 27. The user terminal replies to with a “RRC: RB setup response” message 28.

Once SRNS Relocation has been completed, the new SRNC also commences communicating with the MSC of the circuit switched component of the Core Network, by forwarding the “RAB assignment response” message 29, that it had previously received from the Node B and buffered. In this regard, in this embodiment of the invention, the RAB assignment response is only forwarded to the MSC once the allocation of radio resources had been completed.

Once the MSC receives the RAB assignment response, the MSC begins to establish the link to the called party, by transmitting the Initial Address Message (IAM) 29. The IAM is the first message sent to inform the partner switch that a connection is to be established. The IAM contains the called and calling number and an indication of the type of service (i.e. speech or data).

It is to be appreciated that this arrangement is likely to take slightly longer than a normal RAB establishment—due to the SRNS Relocation being involved. Therefore, it may be necessary to configure the MSC to wait a longer period of time to receive the RAB Assignment Response message 28.

Nevertheless, overall, on a per message basis, this embodiment of the invention will generally allow CS call setup messages to be passed quickly through the UTRAN, particularly since the CS messages also get the benefit of Radio Resource Control (RRC) and Radio Link Control (RLC) occurring within the Evolved Node B.

In a further embodiment of the invention, the procedure is as per the embodiment just described, however a variation relates to the UTRAN RNC's treatment of the “RAB Assignment Request” message received from the CS Core Network. In the FIG. 2 embodiment, the UTRAN RNC stores a copy of the RAB Assignment Request message before forwarding it onto the evolved Node B. In this further embodiment of the invention, however, rather than storing this message and forwarding it on, the UTRAN RNC instead rejects the message with cause “Relocation triggered”, which is transmitted back to the Core Network. The UTRAN RNC also notifies the eHSPA Node B of this via the Iub interface. SRNS Relocation then occurs, as described in relation to the embodiment above, but with the RAB Assignment yet to occur. It is then the responsibility of the Core Network to attempt the RAB Assignment again once the SRNS Relocation has been successfully completed.

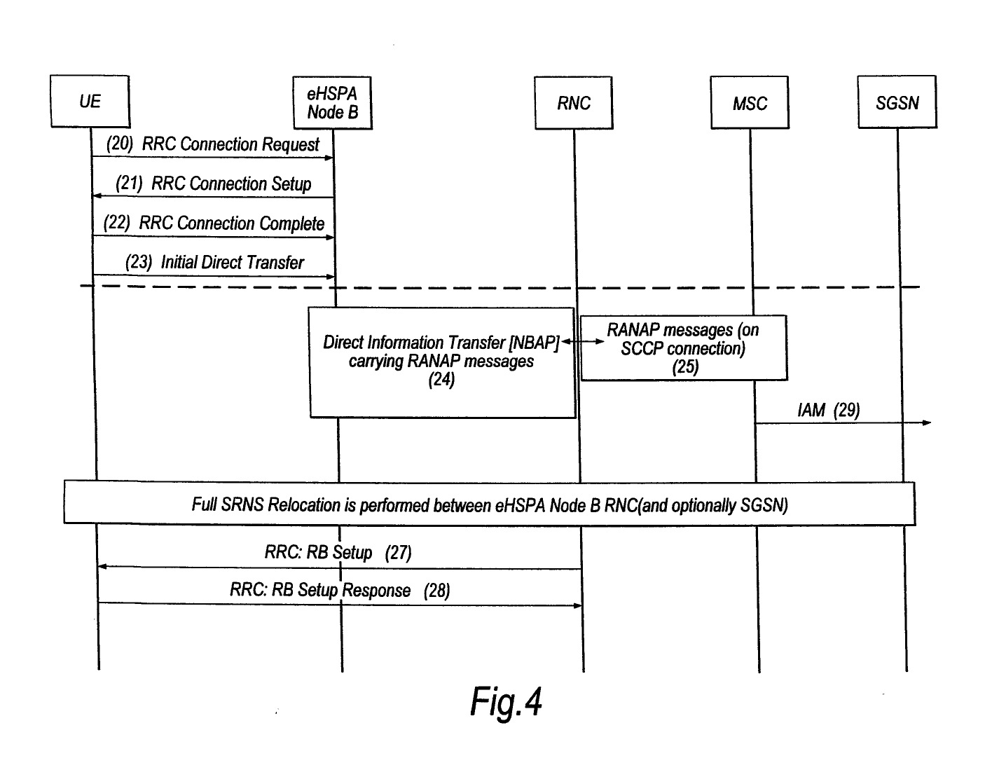

A still further embodiment of the invention is shown in relation to FIG. 4, where the CS call Iub radio link is established before SRNS Relocation occurs. As with the FIG. 2 embodiment of the invention, the user terminal (UE) initiates communication from idle, by sending a “Radio Resource Request (RRC) Connection Request” 20 to the nearest Node B, which in this instance is to the eHSPA Node B 10. Upon receiving this request, the Node B proceeds with registering its internal RNC 11 as the serving RNC, since at this point in the communication it is unable to determine whether the user terminal requires access to the circuit switched component or the packet switched component of the core network.

Once the RRC connection has been set up, it notifies the user terminal via an “RRC Connection Setup” message 21. The user terminal acknowledges this with an “RRC connection complete” message 22. Next the user terminal, either connecting from idle or already having a PS connection established, sends an “Initial Direct Transfer” message 23 to the Node B 10. It is from this message that the Node B can now determine the type of communication required by the user terminal: that is whether the terminal requires a circuit switched connection to the core network or a packet switched connection. In this embodiment, the terminal requires a circuit switched connection, to which the Node B's inbuilt RNC is not compatible. Therefore, an SRNS Relocation needs to occur to a more appropriate RNC so that the required CS connection can be established.

Communications to effect a CS connection normally occur between the SRNC and the CS component 17 of the Core Network over the Iu interface using RANAP. This is not possible in the present instance, since the SRNC 11 is only in direct communication with the PS component 14 of the Core Network.

Therefore, according to this embodiment of the invention, the Node B functionality 13 of evolved Node B 10 takes the responsibility for communicating the Direct Information Transfer messages 24, 25 required to set up the CS core network connection.

In FIG. 4, no specific detail of the Direct Information Transfer messages 24, has been given, as their actual content is not important to this embodiment of the invention. It is enough to merely appreciate that the messages communicated between the evolved Node B and the MSC of the CS Core network at this stage of the call set up would typically include the initial RANAP call setup message as well as security mode commands.

The first of the RANAP messages to be transferred is typically the “Initial UE” message from the evolved Node B to the CS component 17 of the Core Network.

Therefore, according the present embodiment of the invention, the Node B encapsulates this RANAP message into an NBAP “Direct Information Transfer” container for transmission over the Iub interface towards the UTRAN RNC 15. The UTRAN RNC is the RNC to which the SRNC functionality is to be reallocated.

As was the case for the FIG. 2 implementation, at this stage in the procedure the UTRAN RNC is not directly involved in the communications between the CS component of the Core Network (i.e. the MSC), and the Node B, and so, upon receiving the “Direct Information Transfer” container, the RNC merely unpacks the RANAP message, and transmits it to the MSC 17 of the CS core network using an SCCP connection. In other words, the RNC has no involvement in the processing of the RANAP message at this stage—it merely acts as a conduit for the message towards the Core Network.

Upon handling the initial RANAP call set up message transfer, the Core Network will eventually send the “RAB Assignment Request” message, to establish the Radio Access Bearer (RAB) for the communication. This RANAP message would again be transmitted to the UTRAN RNC across the Iu-CS interface. In this embodiment of the invention, upon receiving this message, the UTRAN RNC encapsulates the message in a NBAP “Direct Information to Transfer” container before relaying it on to the Node B over the Iub interface. Upon receiving the “RAB Assignment Request”, the Node B performs admission control and sets up the Radio Link configuration in the eHSPA Node B, and then responds with a “RAB Assignment Response” RANAP message, which is transmitted towards the UTRAN RNC over the Iub interface, again in is an NBAP “Direct Information Transfer” container. When the UTRAN RNC receives the “RAB assignment Response” RANAP message, it unpacks the message and relays it to the MSC of the CS Core Network. The MSC responds by sending an “Initial Address Message” (TAM) 29, to inform the partner switch that a connection is to be established between the user terminal and the called party.

At this stage, the Node B's RNC is still the SRNC, and so SRNS Relocation still needs to occur before the CS connection between the user terminal and the called party can be fully established. Therefore, after sending the RAB Assignment Response message towards the UTRAN RNC, the eHSPA Node B triggers the SRNS Relocation by forwarding the “Relocation Commit” message to the UTRAN RNC in NBAP across the Iub interface. Alternatively, in the situation of a PS connection already existing, it may perform the SRNS Relocation via the SGSN, and then send the Relocation Commit message to inform the UTRAN RNC that it shall consider itself the new Serving RNC.

As per the FIG. 2 embodiment, an example of an applicable SRNS Relocation procedure, where no connection to the core network current exists, is shown in FIG. 3, commencing below the dotted line 30. (The procedure above the dotted line 30 relates to the procedure for moving an Iu-PS connection from an enhanced Node B's SRNC to a legacy RNC, where an Iu-PS connection already exists.)

The procedure below the dotted line in FIG. 3 is mainly performed by the UTRAN RNC, and its functionality is as detailed in UTRAN 3GPP Release 7 to specifications, from the stage when the UTRAN RNC receives the message “Relocation Commit” triggering SRNS Relocation if there is no existing core network connection. According to the present embodiment of the invention, instead of this message being forwarded between legacy RNCs over the Iur interface using the RNSAP protocol, an equivalent message 31 is forwarded by the evolved Node B to the UTRAN RNC over the Iub interface using the NBAP protocol. In addition, the full SRNS context including the radio bearer or signalling radio bearer (on which to transmit the RRC signalling) information intended to be used by the UTRAN RNC may be transmitted across the Iub interface within this message. Particularly this is needed if there is no existing core network connection, If there is an existing PS core network connection, then the message may be used to inform the UTRAN RNC that it may consider itself the new Serving RNC once the SRNS context has been transferred over the Iu-PS interfaces. Although not shown in FIG. 3, in both cases there may also be a preparation phase on which to prepare the UTRAN RNC for the pending SRNS Relocation, which may involve interaction where the node controller is required to inform the terminal of the configuration to be used following the SRNS Relocation. There may also be some additional signalling between UTRAN RNC and node controller to allow the UTRAN RNC to inform the node controller whether the requested actions related to the SRNS Relocation can be carried out. In addition, such interaction may involve the UTRAN RNC tunnelling an RRC message to the node controller to allow it to inform the user terminal of the radio bearer configuration that shall be used following the SRNS Relocation.

Once SRNS Relocation has been triggered by the eHSPA node in this way, subsequent steps below the dotted line 30 in FIG. 3 are standard steps currently used in the UTRAN SRNS Relocation procedure and will not be described further here.

After the SRNS Relocation is successfully completed, the UTRAN RNC to becomes the SRNC and from that point stops relaying RANAP messages to the eHSPA node B, and starts to function as the SRNC for the user. The eHSPA Node B also again starts to function as a normal Node B.

It is to be appreciated, however, that in this embodiment, the user plane resources have not yet been fully allocated to the new SRNC, since the eHSPA Node B did not have the Iub user plane resources established towards it before performing the SRNC Relocation.

Therefore, again referring to FIG. 4, once SRNS Relocation 26 has been effected, and the UTRAN RNC has become the SRNC, it establishes the Iub user plane towards the Node B, then sends the user terminal the “RRC: RB setup” message 27. The user terminal replies to with a “RRC: RB setup response” message 28.

In FIG. 3 it does not show the Iub resources being setup to be able to transmit the RRC messages following the SRNS Relocation. However this would be needed to be done prior to the UTRAN RNC sending the UTRAN Mobility Information to the UE.

A benefit of this solution is that there is less additional delay to the call set up, because configuration of the radio link and admission control are performed before SRNS Relocation, allowing the called party's connection to be established concurrently with the SRNS Relocation. In other words, the set up delay is reduced, due to an overlap in the set up procedures, rather than waiting for the SRNS relation to occur before finalising the communication link to the called party, as occurs in the FIG. 2 embodiment of the invention.

A further embodiment of the invention relates to a variation of the embodiment just described. In this further embodiment, the CS call radio link is again established before SRNS Relocation occurs, and the user terminal (UE) initiates communication from idle. Therefore, the communications 20, 21, 22, 23 between the UE and the evolved Node B occur as per FIG. 4 and the previously described embodiment, and the Node B proceeds with registering its internal RNC 11 as the serving RNC.

Once the Node B receives the “Initial Direct Transfer” message 23 from the user terminal (either connecting from idle or already having a PS connection), the Node B is then able to determine whether the terminal requires a circuit switched connection to the core network or a packet switched connection. In this embodiment, the terminal requires a circuit switched connection, with which the Node B's inbuilt RNC is not compatible. Therefore, an SRNS Relocation needs to occur to a more appropriate RNC so that the required CS connection can be established.

Hence, the Node B functionality 13 of evolved Node B 10 takes the responsibility for communicating the initial RANAP messages 24 to the CS component 17 of the Core Network.

As per the previous embodiment of the invention, the Node B encapsulates this RANAP message into an NBAP “Direct Information Transfer” container for transmission over the Iub interface towards the UTRAN RNC 15. The UTRAN RNC is the RNC to which the SRNC functionality is to be reallocated.

At this stage in the procedure the UTRAN RNC is not directly involved in the communications between the CS component of the Core Network (i.e. the MSC), and the Node B, and so, upon receiving the “Direct Information Transfer” container, the RNC merely unpacks the RANAP message, and transmits it to the MSC 17 of the CS core network using an SCCP connection. Upon receiving the initial RANAP message, the Core Network responds.

The UTRAN RNC will relay all RANAP messages between the Core Network to and the evolved Node B in this way, until the Core Network sends the “RAB Assignment Request” message, to establish the Radio Access Bearer (RAB) for the communication. In this embodiment of the invention, upon receiving the RAB Assignment request message, the UTRAN RNC acts as the RNC and sets about establishing the radio link configuration towards the Node B using is NBAP.

At this stage, the Node B's RNC is still the SRNC, and so SRNS Relocation still needs to occur before the CS connection between the user terminal and the called party can be fully established. Therefore, after sending the Radio Link Setup/Reconfiguration Response message towards the UTRAN RNC, the eHSPA Node B triggers the SRNS Relocation by forwarding the “Relocation Commit” message to the UTRAN RNC in NBAP across the Iub interface.

The evolved Node B triggers relocation in this way in view of the behaviour of the UTRAN RNC in establishing the user plane resources towards the Node B. That is the Node B recognises that the UTRAN RNC is performing some of the functions of the SRNC, and so then performs an SRNS relocation so that the UTRAN RNC is able to perform fully as the SRNC.

Once SRNS Relocation has been triggered by the eHSPA node, subsequent steps proceed as per those illustrated below the dotted line 30 in FIG. 3, which are standard steps currently used in the UTRAN SRNS Relocation.

Once the admission control has been successfully completed and the SRNS Relocation has been completed towards the UTRAN RNC, the evolved Node B notifies the UTRAN of such, and the UTRAN RNC then transmits the “RAB Assignment Response” RANAP message to the Core network. The MSC responds by sending an “Initial Address Message” (IAM) 29, to inform the partner switch that a connection is to be established between the user terminal and the called party.

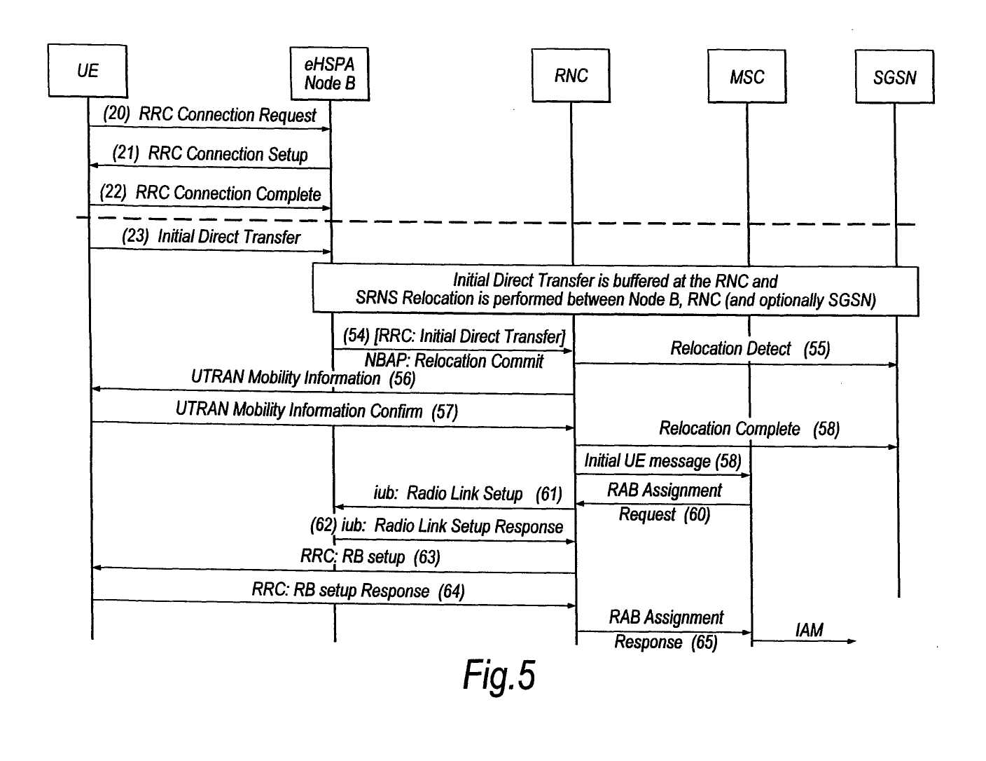

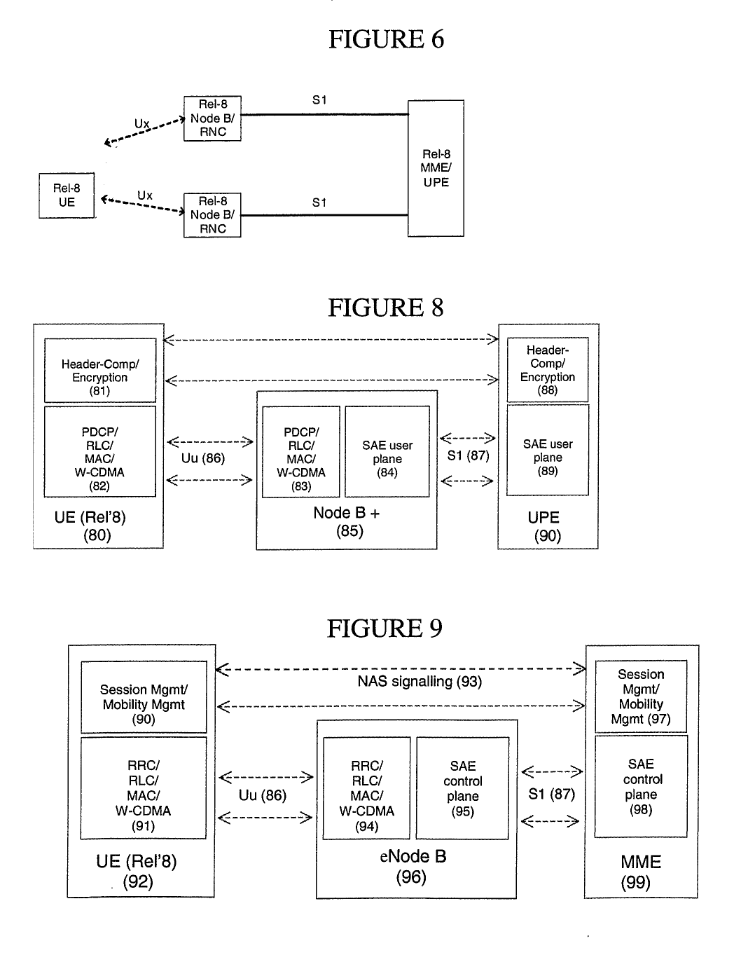

A still further embodiment of the invention will now be described in relation to FIG. 5. In this embodiment, the user terminal (UE) requests a CS connection from idle. The user terminal first sends a “Radio Resource Request (RRC) Connection Request” 20 to the eHSPA Node B 10. The Node B notifies the user terminal that the connection is set up via an “RRC Connection Setup” message 21. The user terminal acknowledges this with an “RRC connection complete” message 22. Next the user terminal sends an “Initial Direct Transfer” message 23 to the Node B 10. It is from this message that the Node B determines the type of connection required by the terminal (either connecting from idle or already having a PS connection). In this embodiment, in addition to its existing PS connection, the terminal requires a circuit switched connection, with which the Node B's internal RNC is not compatible. Therefore, an SRNS Relocation needs to occur to a more appropriate RNC before the user terminal can communicate via its requested CS connection.

According to this embodiment of the invention, the Node B functionality 13 of evolved Node B 10 takes the responsibility for triggering access to the CS domain, as well as triggering SRNS relocation from its internal RNC to the UTRAN RNC. In this regard, the evolved Node B tunnels the Initial Direct Transfer message (triggering access to the CS domain) within an NBAP message (which in the figure is the “Relocation Commit” message 54—(used during SRNS relocation and potentially carrying the SRNS context)) through to the UTRAN RNC. In this regard, the Initial Direct Transfer message is encapsulated in the Iub control signalling (NBAP) and tunnelled through to the UTRAN RNC.

Once received, the RNC buffers the “Initial Direct Transfer” message until the SRNS relocation has been effected. Further, in response to the SRNS Relocation Commit message, the UTRAN RNC (with an existing PS connection effects the SRNS Relocation by first sending a “Relocation Detect” message 55 to the SGSN of the PS component of the core network, and) then sends a “UTRAN Mobility Information” request message 56 to the UE. The UE replies with a “UTRAN Mobility Information Confirmation” message 57, (and the UTRAN RNC with an existing PS connection in turn notifies the SGSN of such with a “Relocation Complete” message 58).

With SRNS Relocation completed, the UTRAN RNC, now the SRNC, forwards the “Initial Direct Transfer” message 59, previously buffered, to the MSC to set up the CS connection. The MSC replies with a “RAB Assignment Request” 60. The RNC then forwards a “Radio Link Setup” message 61 to the eHSPA Node B over the Iub interface. Since SRNS Relocation has occurred, the eHSPA Node B acts as a normal Node B and sets up the Radio Link before transmitting a “Radio Link Setup Response” 62 to the RNC once the link has been set up. The RNC then notifies the UE that the Radio Bearer has been set up, via the “RRC: RB Setup” message 63. The UE responds with a “RRC: RB Setup Response” message 64. The RNC then confirms the RAB Assignment with the MSC 65, so that the call connection with Party B can be effected.

This embodiment of the invention therefore uses the UTRAN RNC to effect SRNS Relocation before the CS Core Network is notified of the CS Connection Request.

The embodiments of the invention so far described, relate different procedures for setting up a CS call for a user terminal from idle or when already PS connected, be it a legacy terminal or otherwise. The inventive concept can similarly be applied to the situation of a legacy terminal that is not HSPA compatible, such as a Release 99 (or earlier) compatible terminal, requesting a PS call set up. In this regard, since the legacy terminal is not HSPA compatible, the PS connection cannot be established via the eHSPA's internal RNC, but must be via a UTRAN RNC.

The embodiments of the invention so far described may also be applied to the situation of a user terminal requesting a CS connection, where a PS connection has already been established with the eHSPA Node B's inbuilt SRNC.

In this regard, where the user terminal has an existing PS connection to the core network, via the evolved Node B's internal SRNC 11, and the user terminal requests a CS connection. Since the SRNC of the evolved Node B cannot provide such a CS connection, and it is desirable to have the same SRNC to provide both the PS and the CS connection, it is necessary in this situation for the evolved Node B to initiate an SRNS transfer to a UTRAN RNC.

This SRNS Relocation procedure is shown in FIG. 3. Above the dotted line the necessary steps to move the Iu connection from the Node B's internal SRNC to the UTRAN SRNC are detailed. The eHSPA node first transmits a “Relocation Required” message 31 to the SGSN of the PS core network. This message can be transmitted to the SGSN via the Node B's SRNC since a PS connection with the SGSN has already been established. Alternatively, the message could be routed via the UTRAN SRNC.

When the SGSN receives the “Relocation Required” message, the SGSN notifies the UTRAN RNC of the Iu-PS Relocation requirement by sending it a “Relocation Request” message. Based upon this message, the UTRAN RNC sets about establishing its appropriate RABs. Once complete, it notifies the SGSN via the “Relocation Request Acknowledgement”. The SGSN then sends a “Relocation Command” to the SRNC of the eHSPA Node to effect the Iu-PS transfer from its own SRNC to the UTRAN SRNC.

Once the eHSPA Node B has arranged the relocation of the Iu-PS connection with the core network to the UTRAN RNC, the SRNS Relocation needs to be effected from the Node B's internal SRNC to the UTRAN RNC. According to this further embodiment of the invention, the evolved Node B initiates this transfer by forwarding a “Relocation Commit” message 36 to the UTRAN RNC over the Iur interface using NBAP.

Once SRNS Relocation has been triggered by the eHSPA node, the steps outlined below the dotted line in FIG. 3 are performed. This stage of the procedure may also be used for a UE that does not have an existing PS connection. This procedure is mainly performed by the UTRAN RNC, and its functionality is as detailed in UTRAN 3GPP Release 7 specifications, once it receives the message “Relocation Commit” triggering SRNS Relocation, or informing the RNC that it may consider itself the new Serving RNC for the connection. According to the present embodiment of the invention, instead of this message being forwarded between RNCs over the Iur interface using the RNSAP protocol, an equivalent message is forwarded by the evolved Node B to the UTRAN RNC over the Iub interface using the NBAP protocol. This message may also contain the full SRNS context.

Once SRNS Relocation has been triggered by the eHSPA node, subsequent steps below the dotted line in FIG. 3 are standard steps currently used in the UTRAN SRNS Relocation procedure and will not be described further here.

Once the SRNC functionality has been transferred to the UTRAN RNC in this way, the eHSPA Node B begins to function as a standard Node B.

Although the embodiments above have been described in relation to a UMTS Radio Access Network, the same principles may be applied to an LTE network, it) transferring non-compatible UEs to a UTRAN.

A further embodiment of the invention will now be described in relation to implementing a transitional arrangement for an LTE/SAE network combined with a UTRAN, in order to cater for legacy terminals.

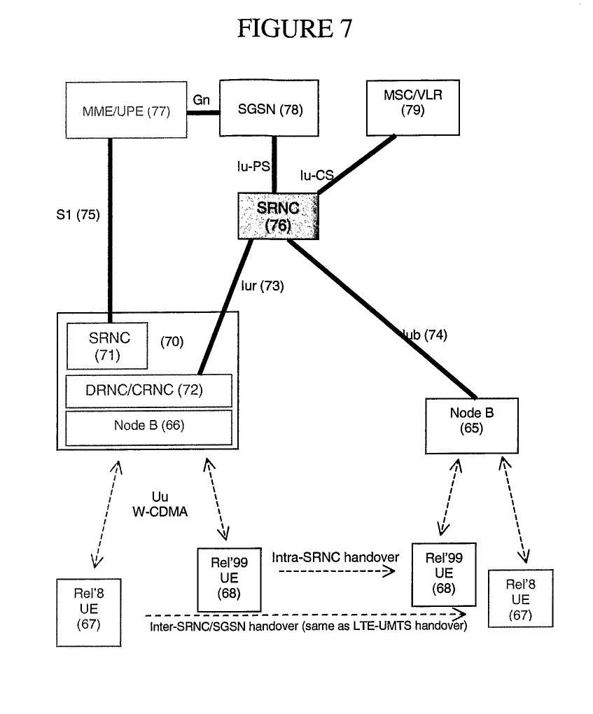

In FIG. 7, an evolved HSPA Node B is in communication with the MME/UPE from the LTE/SAE network via an S1 interface, or equivalent. The evolved Node B is in communication with a legacy RNC via its inbuilt RNC, using an Iur interface. The legacy RNC is in communication with legacy Node Bs via an Iub interface. The legacy RNC is also in communication with the legacy SGSN and MSC/VLR over an Iu interface.

The connectivity between the eHSPA Node B and the legacy RNC over the Iur interface has some advantages over connectivity via Iub to the legacy RNC in that it allows the cell management to be performed in a single place. In this regard, RRC termination for newly established legacy calls will naturally be terminated in the legacy Node B, even with the Release 99 UTRAN architecture, using existing mechanisms for transferring RRC messages from a DRNC to an SRNC., The Iur interface has also developed into a more commercially interoperable interface in a multi-vendor network than the Iub interface.

Since with this SAE connectivity architecture, the evolved HSPA Node B may not be compatible with legacy UEs, when such a UE transmits a RRC Connection Request to the evolved Node B, then it is necessary for the evolved Node B to transfer the UE to a UTRAN Node B in order for the UEs communication request to be fulfilled.

To implement this transfer, the eNode B initiates an SRNC handover by transmitting a “Relocation Commit” message, or equivalent triggering to message, to trigger the SRNS Relocation. In the some of the previous embodiments, this was performed by tunnelling the “Relocation Commit” message over the Iub interface from the Node B functionality of the eNode B to a UTRAN RNC, however this was just an example and any interface between eHSPA Node B and legacy RNC could actually be used. Hence in the present embodiment, an Iur interface is used between the RNC functionality of the eNode B's RNC and the UTRAN RNC.

Once the UTRAN RNC receives the triggering message, the remaining functionality of the SRNS Relocation is as detailed in UTRAN 3GPP Release 7 specifications, although small modifications are needed to allow signalling bearers to be maintained such that the legacy RNC can communicate to the UE with RRC messages.

This embodiment of the invention applies to all UEs that seek to connect to the network via the eHSPA Node B that do not have S1 interface connectivity. Without this connectivity, the UE is unable to communicate through the eHSPA Node B to the SAE core network, and hence needs to be handed over to UTRAN network components in order to make a PS and/or CS connection. In other words, as the eHSPA Node B in this architecture will typically only support IP based interfaces, the legacy SRNC can provide the interworking between packet switched technologies (e.g. ATM) and the IP based interfaces.

It is also to be appreciated that this embodiment of the invention may also be applied to communications between eHSPA Node Bs in a UMTS Radio Access Network, and UTRAN RNCs.

A further embodiment of the invention addresses issues that have arisen in the proposed LTE/SAE network, in view of the RNC functionalities being moved into the Node B. To reiterate, with the RRC function being moved to the Node B, this causes all functionality below RRC to also be moved to the Node B, and thus ciphering would be in Node B.

Therefore, to provide an alternative to this arrangement, according to the present embodiment of the invention, it is proposed to switch off the existing ciphering functions in the RNC in the Node B, and use the protocol layers of the SAE architecture to provide the ciphering function in a higher level node. Packet Data Convergence Protocol (PDCP) header compression would also be moved up to a higher node, namely the UPE. Therefore, in effect, according to this embodiment of the invention, the SRNC functionalities are divided between the eNode B and the MME/UPE, such that the SRNC control plane functionality is retained in the eNode B, whilst the SRNC user plane functionalities are undertaken by the MME/UPE.

This division is represented in FIG. 8 in respect of the user plane architecture. An SAE compatible UE 80 (currently often described as a 3GPP Release 8 terminal, but further releases are likely, so these embodiments are not limited to such a terminal), is in communication with the eNode B 85 over the Uu interface. The eNode B 85 has its header compression functionality 83 switched off, so it does not perform PDCP. Its Radio Link Control (RLC) encryption is also switched off 83. The eNode B therefore only communicates directly with the UE in relation to user plane issues using Medium Access Control (MAC) protocol, unencrypted RLC protocol and WCDMA. In this architecture we are still using W-CDMA, but we are not using soft combining, so we are re-using the type of Radio Access Network (RAN) architecture that has been agreed for 3GPP SAE/LTE, thus allowing migration from the UMTS core network to the 3GPP Evolved Packet-switched Core Network).

The encryption and header compression functionalities 81, in the FIG. 8 example, are instead provided to the UE by communicating directly with the UPE 90. In this regard, the UPE has the resources to provide the required encryption and header compression functionalities 88.

The eNode B 85 is also able to communicate directly with the UPE 90 over an SAE user plane 84, 89. The interface for this plane is the S1 interface 87, or an S1-like interface.

Next referring to FIG. 9, the division is represented in relation to the control plane architecture. In this Figure, the eNode B 96 is in communicable relation with the MME 99 over an SAE user plane 95, 98. The interface for this plane is the S1 interface 87, or an S1-like interface.

The SAE compatible UE 92, is in communication with the eNode B 96 over the Uu interface. The eNode B 96 maintains full control over control plane issues communications with the UE for Radio Resource Control, and control plane communications in Radio Link Control protocol, MAC protocol and WCDMA.

In the control plane, functionality in relation to which the MME 99 communicates directly with the UE 92, is that of Session Management and Mobility Management 90, 97. In this regard, the MME will be in communication with all eHSPA Node Bs in a given geographical area, and therefore manage the transfer of the UE between eHSPA Node Bs, as the UE moves. These communications typically utilise Non-Access Stratum (NAS) signalling.

In an alternative embodiment to that just described, instead of turning the ciphering off in the eHSPA Node B, the ciphering functions are performed twice: once in the UPE and once at the RLC layer in the eNode B's SRNC. This alternative avoids adding control complexity, and also eases compatibility considerations with UEs and legacy Node Bs that the eNode B may be in communication with.

In another alternative, combined with either or both the above two embodiments; the Header Compression is not turned off in the eNode B, so that again Header Compression can be performed twice.

Referring to FIG. 7, an example LTE/SAE architecture is illustrated, with an eHSPA Node B 70. In this Figure the user planes are illustrated where the network does not support soft handover for the HSPA radio access technology. In this regard, the type of RAN architecture that has been agreed for 3GPP SAE/LTE, thus allowing migration from the UMTS core network to the 3GPP Evolved Packet-switched Core Network.

As an LTE compatible terminal 67 moves from eNode B 70 towards the legacy Node B 65, the MME handles the transfer, in conjunction with the eNode B 70. That is the MME 77 notifies the SGSN 78 of the legacy UTRAN of the movement of UE 67 toward Node B 65. SGSN will therefore set up the transfer and make legacy RNC 76 the Serving RNC.

Where a legacy UE 68 seeks to establish a communication through the eNode B 70, since this UE is not SAE compatible, it is necessary to transfer the UE from the eHSPA Node B, to the legacy network. This is performed by the RNC of the eNode B communicating with the legacy RNC over the Iur interface. In effect the eNode B will be completing an inter-RNC handover (i.e. from the RNC of the eNode B, to the legacy RNC 70). This transfer is also necessary where the eNode B has its ciphering turned off: for the legacy UE to be afforded security, it will need to be managed by a legacy RNC 76, where the security provisions are remote from the Node B 65.

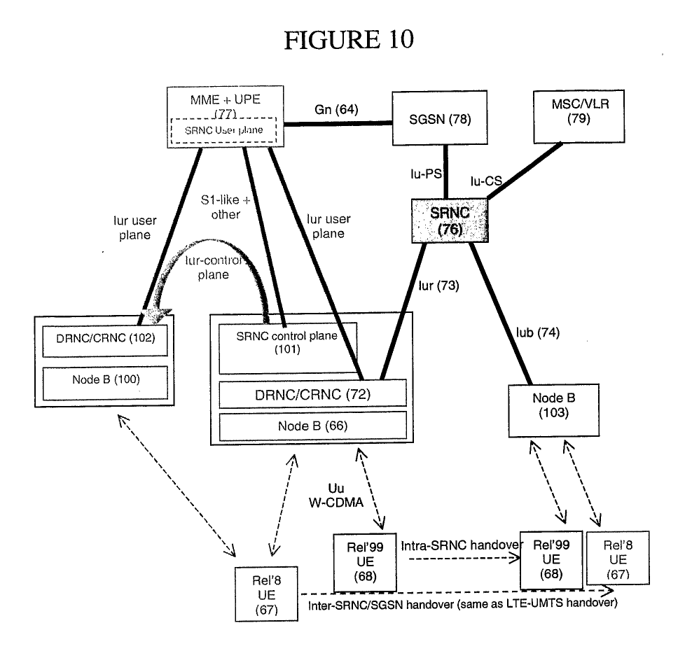

FIG. 10 illustrates the same LTE/SAE architecture as FIG. 7, with an evolved eHSPA Node B 70. In FIG. 10, however, the user planes are illustrated where the network does need to support soft handover for the HSUPA radio access technology. In this regard, where a SAE compatible UE moves from eNode B 70 to eNode B 100, soft handover is managed by both the SRNC User plane within the MME/UPE 77 and the SRNC control plane 101 within eNode B 70. The UPE communicates with the RNCs of both eNode Bs 100, 70 using an Iur user plane. The RNCs of each eNode B 70, 100 also communicate with one another, this time using an Iur control plane. In this regard, since the control and user plane SRNC functionalities are physically separate in this arrangement, they need to communicate using a new interface, similar to the Iur interface of UTRAN.

It is to be appreciated that in this FIG. 10 arrangement, the use of the UPE to do the macro-diversity combining (ie. Soft handover), means that something resembling an Iur user plane can be terminated between the UPE and the eNode Bs 100, 70 whilst still allowing the ciphering and header compression of the user plane data to be done by the ciphering and PDCP functions respectively residing in the UPE. At the same time given that RRC will terminate in the eHSPA Node B, then the ciphering and integrity protection for this function would need to be part of the eHSPA Node B.

It is to be appreciated that the embodiments of the invention just described are for illustrative purposes only and the exact procedures are not to be interpreted as limiting. For example, once the SRNS relocation procedure has been initiated, it is within the scope of the invention that other RANAP procedures, such as procedures initiated by the Core Network or the enhanced HSPA Node B itself, may require the SRNS relocation procedure to be terminated or delayed in order to allow the particular RANAP procedure to be undertaken.

1. A method of establishing a communication in a telecommunications network, the telecommunications network including a base station node having a node controller and a first radio network controller (RNC), the first radio network controller component configured to communicate with a packet switched component of a core network, but not with a circuit switched (CS) component, the telecommunications network further including a second RNC configured to communicate with the node controller and also to communicate with the packet switched component of the core network and the circuit switched component, the communication being established between a given user terminal and the core network via the second RNC, when a given user terminal has at least a control plane connection with the base station node, such that the first RNC is a serving RNC (SRNC), the method comprising:
transmitting at least one message over the control plane between the node controller and the core network via the second RNC, wherein the message is tunnelled between the node controller and the second RNC.

2. The method of claim 1, wherein the second RNC relays the at least one message, by at least one of: placing the message in a control plane container for transmission over the control plane interface to the node controller, and removing the message from a control plane container for transmission over the control plane interface to the core network.

3-57. (canceled)

58. The method of claim 1, further comprising:
tunnelling the at least one message in a control plane container between the node controller and the second RNC over the Iub interface; and
upon receiving the control plane container, the second RNC removing the message therefrom and relaying the message on the control plane of the Iu interface to the core network.

59. The method of claim 1, further comprising:
transmitting the at least one message from the core network to the second RNC over the Iu interface; and
the second RNC receiving the message from the Iu interface and relaying the message in a control plane container over the Iub interface to the node controller.

60. The method of claim 1, wherein the at least one message is tunnelled over the control plane once the node controller determines that the given user terminal requires access to the circuit switched component of the core network.

61. The method of claim 1, wherein the at least one message is tunnelled over the control plane once the node controller determines that the given user terminal requires a type of call that cannot be setup directly from the base station node towards the packet switched component of the core network.

62. The method of claim 61, wherein the node controller determines that the given user terminal requires a packet switched connection using 3GPP Release 99 channels, wherein a connection cannot be set up directly towards the packet switched core network from the base station node.

63. The method of claim 61, wherein the node controller determines that the given user terminal requires a circuit switched connection, wherein a connection cannot be set up directly from the base station node.

64. A method of initiating SRNS relocation in a telecommunications network, the telecommunications network including a base station node having a node controller component and a first radio network controller (RNC) component, the first radio network controller configured to communicate with a packet switched component of a core network, but not with a circuit switched component, the telecommunications network further including a second RNC configured to communicate with the node controller and also to communicate with the packet switched component of the core network and the circuit switched component, the SRNS relocation being initiated from the first RNC to the second RNC, when a given user terminal has at least a control plane connection with the base station node, such that the first RNC is a serving RNC (SRNC), the method comprising:
transmitting an SRNS relocation message from the node controller to the second RNC across the Iub interface.

65. The method of claim 64, wherein the SRNS relocation message is intended to trigger the SRNS relocation.

66. The method of claim 64, wherein the SRNS relocation message is intended to inform the second RNC that the second RNC should consider itself the serving RNC for a user connection.

67. The method of claim 64, wherein the SRNS relocation message contains a radio bearer configuration intended to be used by the second RNC when the second RNC considers itself to be the serving RNC.

68. A telecommunications system configured to implement the method of claim 64.

69. A base station node, comprising:
a node controller; and
a first radio network controller (RNC) component, the first radio network controller configured to communicate with a packet switched component of a core network using HSPA, but not with a circuit switched component, wherein the node controller is further configured to transmit at least one communication set up message over the control plane between the node controller and the core network via a second RNC, such that the at least one message relates to a first protocol and the base station node is configured to encapsulate the message in a control plane container according to a second protocol.

70. The base station node of claim 69, wherein the node controller is configured to transmit at least one RANAP message and encapsulate the message in an NBAP container for transmission across the Iub interface towards the core network via the second RNC.

71. A method of establishing a communication in a telecommunications network, the telecommunications network including a base station node having a node controller component and a first radio network controller (RNC), the first radio network controller component configured to communicate with a packet switched or IP component of a core network, but not with a circuit switched component, the telecommunications network further including a second RNC configured to communicate with the node controller and also to communicate with the packet switched component of the core network and the circuit switched component, the communication being established between a given user terminal and the core network via the second RNC, when a given user terminal has at least a control plane connection with the base station node, such that the first RNC is the serving RNC (SRNC), the method comprising:
transmitting at least one message over the control plane between the first RNC component of the base station node and the second RNC, such that the message is transmitted over an Iur interface.

72. A method of communicating with a given user terminal in a telecommunications network, the telecommunications network including a base station node having a node controller component and a first radio network controller (RNC) component, the first radio network controller component configured to communicate with a packet switched or IP component of a core network, but not with a circuit switched (CS) component, the telecommunications network further including a network controller configured to communicate with the node controller and also to communicate with the packet switched component of the core network, the method comprising:
the base station node communicating with the given user terminal in regard to one or more SRNC control plane functionalities; and
the network controller communicating with the user terminal in relation to one or more SRNC user plane functionalities.

73. A telecommunications system configured to implement the method of claim 72.

74. A telecommunications network, comprising:
a base station node having a node controller and a first radio network controller (RNC), the first radio network controller component configured to communicate with a packet switched or IP component of a core network, but not with a circuit switched (CS) component; and
a network controller configured to communicate with the node controller and also to communicate with the packet switched or IP component of the core network, wherein when the first RNC is operating as a serving RNC (SRNC), the first RNC is configured to perform SRNC control plane functionality and the network controller is configured to perform user plane functionality.

75. A telecommunications system configured to implement the method of claim 74.

76. A base station node, comprising:
a node controller component; and
a first radio network controller (RNC), the first radio network controller configured to communicate with a packet switched or IP component of a core network using HSPA, but not with a circuit switched component, wherein the node controller is further configured to transmit at least one communication set up message over the control plane to a second RNC configured to communicate with the packet switched component of the core network and the circuit switched component, such that the at least one message is transmitted between the first RNC of the base station node and the second RNC over an Iur interface.
